(19) United States
(12) Patent Application Publication
(10) Pub. No.: US 2025/0002256 A1
(43) Pub. Date: Jan. 2, 2025

(54) Lifting Device and Method for Manipulating Appliance

(71) Applicant: Midea Group Co., Ltd., Beijiao (CN)

(72) Inventors: Michael Harris, Tappan, NY (US); Wei-Hao Liao, Hamilton, OH (US); Zachary Weston, Blacksburg, VA (US)

(21) Appl. No.: 18/217,088

(22) Filed: Jun. 30, 2023

(51) Int. Cl. B65G 7/12; B65B 69/00

(52) U.S. Cl. CPC B65G 7/12; B65B 69/00

(57) ABSTRACT

A lifting device and method to manipulate the appliance's position. The lifting device may include one or more handle members. The handle members may be interconnected by one or more loop forming members. The lifting device may include a cradle. The appliance may include one or more lifting points cradled by the one or more lifting devices.

### BACKGROUND

The present embodiments relate to one or more lifting devices for an appliance, with particular embodiments for a lifting device(s) for a window air conditioner unit.

Typical appliances are manipulated or handled by the user directly contacting the surfaces of the appliance with their hands/fingers. However, some surfaces of the appliance contacted by the user may lead to abrasions or lacerations of the hands during manipulation of the appliance. Thus, there is a need for the user to manipulate the appliance via a lifting/carrying device engaging the appliance. For example, when stowing and/or deploying an appliance from packaging.

### SUMMARY

In some embodiments, a lifting device for use with an appliance may include an appliance having a housing. In various embodiments, the housing may include a top wall, a bottom wall, and a plurality of side walls connecting the top wall with the bottom wall. In some embodiments, at least one first side wall of the plurality of side walls may include at least one through aperture. In various embodiments, the appliance may include a pair of handle members and a loop forming member interconnecting the pair of handle members. In some embodiments, the loop forming member may pass through at least one through aperture and cradles a portion of at least one side wall defining the through aperture whereby the pair of handle members and the loop forming member overlap.

In addition, in some embodiments, the appliance may be a window air conditioner unit. In various embodiments, the lifting device may include a second lifting device, wherein the second lifting device engages at least one second side wall opposing at least one first side wall. In some embodiments, the pair of handle members may be in a position at an elevation above an uppermost extent of the top wall of the appliance. In various embodiments, each handle member may include opposing recesses, the opposing recesses of each handle member align with each other when the pair of handle members are overlapped. The opposing recesses may be configured to receive the user's finger. In some embodiments, the lifting device may be in combination with a box and/or a packing material between the box and the appliance, wherein the pair of handle members may be disconnected from the packing material. In various embodiments, the portion of at least one first side wall is a horizontal member.

In some embodiments, a lifting device for use with an appliance may include a pair of handle members and a loop forming member interconnecting the pair of handle members. In various embodiments, each handle member may be a T-shaped member. In some embodiments, the lifting device may be configurable between a planar configuration and a folded configuration. In some embodiments, when in the planar configuration the lifting device may be substantially flat and when in the folded configuration the pair of T-shaped members and the loop forming member may overlap to form a cradle.

In addition, in some embodiments, the T-shaped member may include a top member intersecting a base member, wherein each base member of the pair of T-shaped members may engage the loop forming member. In various embodiments, the loop forming member may have a first width and the base member may have a second width, and wherein the first width may be larger than the second width. In some embodiments, the top member may include a third width, wherein the third width may be substantially the same as the first width. In various embodiments, each T-shaped member may include opposing recesses on opposing edges, each opposing recess includes a concave recess opening towards the loop forming member. In some embodiments, each opposing recess may include a tapering recess thereby increasing a width of the T-shaped member from the concave recess towards the loop forming member. In various embodiments, the lifting device may be in combination with a box and/or an appliance. In some embodiments, the pair of T-shaped members or handle members may be similar/different to each other. In various embodiments, the lifting device may be made of a cardboard material.

In some embodiments, a method of manipulating an appliance from packaging may include providing a box. In various embodiments, the method may include providing an appliance in the box, wherein the appliance includes opposing side walls, each of the opposing side walls includes a lifting point. In various embodiments, the appliance may include one or more lifting points. In some embodiments, the method may include providing a lifting device engaging the lifting point, wherein the lifting device includes a pair of handle members and a loop forming member interconnecting the pair of handle members. In various embodiments, the method may include overlapping at least a portion of the pair of handle members and the loop forming member to create a cradle receiving the lifting point of the appliance. In some embodiments, the method may include manipulating the appliance via the lifting devices to stow and/or deploy the appliance relative to the box.

In addition, in some embodiments, the method may include manipulating the appliance via the lifting devices to stow the appliance relative to the box. In various embodiments, the method may include manipulating the appliance via the lifting devices to deploy the appliance relative to the box. In some embodiments, the lifting point may include a least one aperture, and further comprising inserting the lifting device through at least one aperture. In various embodiments, the method may include creating the cradle by overlapping the lifting device about the lifting point. In some embodiments, the method may include opening the box and visually seeing the lifting devices above a top wall of the appliance. In various embodiments, the appliance may be a window air conditioner unit. In some embodiments, each handle member may be a T-shaped member.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of a lifting device consistent with some embodiments of the invention in the folded/looped configuration.

FIG. 2 is a perspective view of the lifting device of FIG. 1 in the planar/unfolded configuration.

FIG. 3 is a top view of the lifting device of FIG. 2 in the planar/unfolded configuration.

FIG. 4 is a perspective view of the lifting device being inserted into or positioned out of the planar configuration towards the folded configuration to cradle or engage the appliance at a lifting point.

FIG. 5 is a perspective view of the appliance and lifting devices stowed in the box, illustrating the opened box and visually seeing the accessible lifting devices to be grasped by the user.

FIG. 6 is a perspective view of the appliance and lifting devices deployed from the box, illustrating the user carrying, stowing, and/or deploying the appliance via the one or more lifting devices.

FIG. 7 is a sectional view of the engaged lifting device taken along line 7-7 of FIG. 6, illustrating the lifting device in the folded configuration cradling/receiving the lifting point of the appliance.

### DETAILED DESCRIPTION

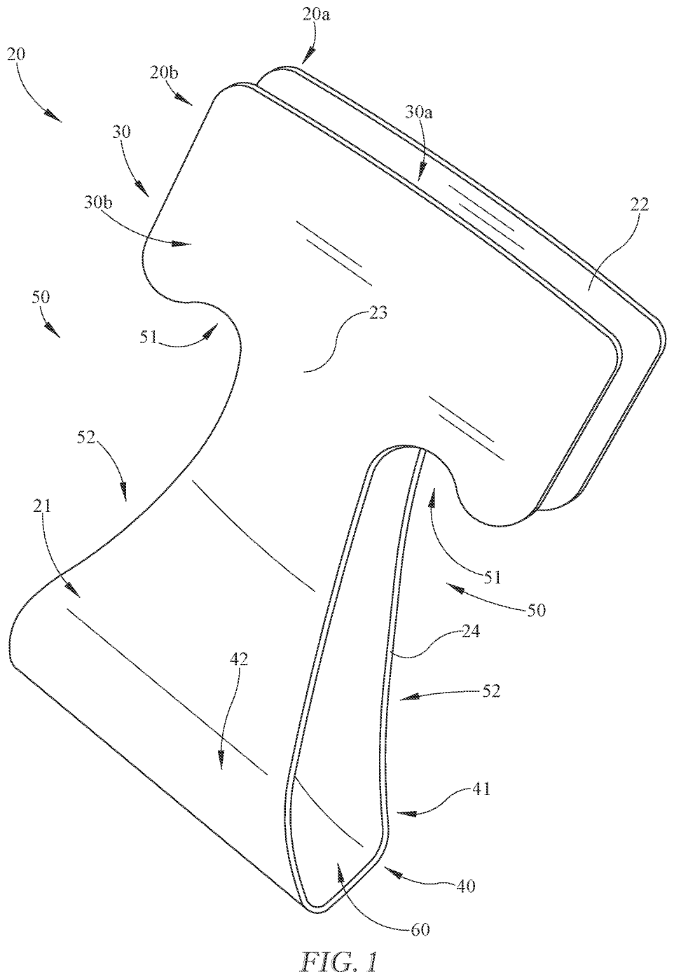

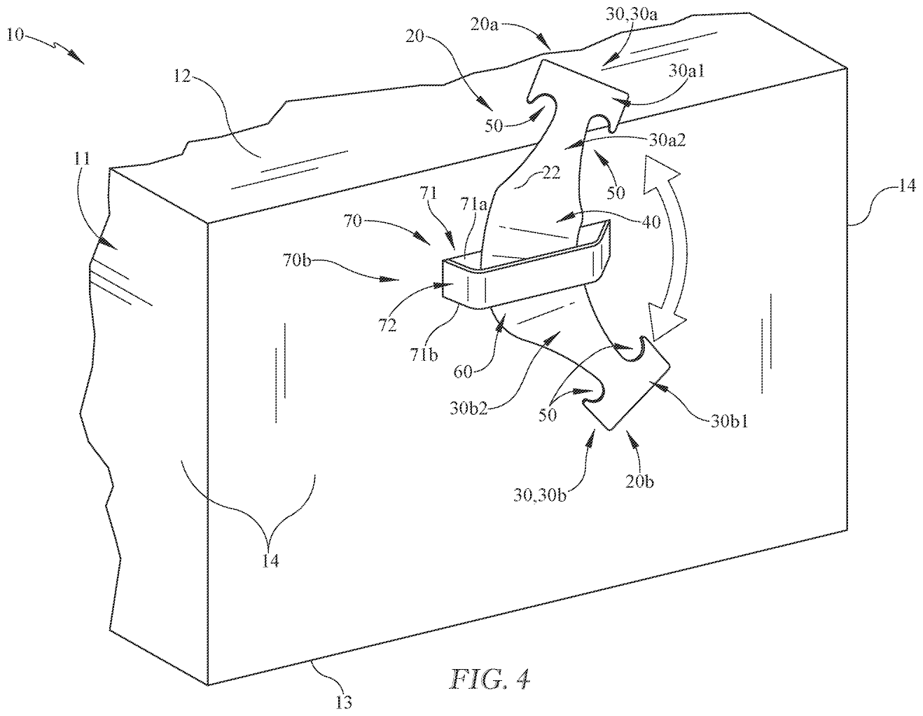

Turning now to the drawings, wherein like numbers denote like parts throughout the several views, FIG. 1 illustrates an example lifting device 20 in which the various technologies and techniques described herein may be implemented. As shown in FIGS. 1-7, in some embodiments, the one or more lifting devices 20 may be used to manipulate (e.g. carrying, stowing within a box/packaging, deploying from a box/packaging, boxing an appliance, unboxing an appliance, lifting, raising, lowering, etc.) an appliance 10. Manipulating the appliance 10 with the lifting devices 20 may be during and/or after manufacturing the appliance. Although two lifting devices 20 are shown engaging the appliance 10, or portions thereof, a single lifting device 20 may be used. The one or more lifting devices 20 may be engaged/disengaged at various times of use. For example, the lifting devices 20 may be engaged with the appliance 10 during and/or after production by one or more users. Further for example, the lifting devices 20 may be engaged to the appliance 10 after opening the box or packaging 1 for deploying the appliance or engaged to the appliance 10 before stowing in the box 1. Although the lifting devices or handles 20 are shown as removeable from the appliance 10, one or more portions of the lifting devices 20 may not be removed from the appliance 10 upon completion of handling of the appliance.

In some implementations, the one or more lifting devices may include a two or more handle members 30. The one or more lifting devices 20 may include at least one loop forming member 40 interconnecting the two or more handle members 30. The lifting device 20 may be elongated and have at least one handle member 30 on the opposing ends 20a, 20b. In the one embodiment shown, the handle member 30 may be substantially T-shaped or be a T-shaped member 30a, 30b. The T-shaped member 30a, 30b may include a top/cross member 30a1, 30b1 transverse (e.g. perpendicular) or intersecting a base member 30a2, 30b2. A proximal end 31 of the top member(s) 30a1, 30b1 projects from an end 33 of the base member 30a2, 30b2 in opposing directions towards a distal free end 32 of the top member(s) 30a1, 30b1. The base member 30a2, 30b2 (e.g. end) is proximal/connected to or engages the opposing ends 41, 42 of the loop forming member 40 in the longitudinal direction along axis A. Each T-shaped member 30a, 30b of the opposing handle members 30 may be similar as shown in the one embodiment, however in some embodiments they may be different. Although a T-shaped member is shown in the one embodiment, a variety of handle members may be used and still be within the scope of the invention. The handle member may be a variety of shapes, sizes, quantities, and constructions and still be within the scope of the invention. For example, the handle member may be shaped to be gripped by the user's fingers/hands. The shape may be heart shaped or enclosed handles in some embodiments.

In some implementations, the lifting device 20, handle member 30, loop forming member 40, and/or T-shaped member 30a, 30b, or portions thereof, may include one or more recesses or cutouts 50. The one or more recesses 50 may be in the outer periphery 21 of the lifting device 20 or portions thereof (e.g. T-shaped member, handle member, loop forming member). The lifting device 20 may include a top surface 22 and a bottom surface 23 interconnected by an outer edge or side wall 24. The opposing edges 24 of one or more lifting devices 20 or handle members 30 may include opposing recesses 50. The one or more opposing recesses 50 may be positioned between the opposing ends 20a, 20b of the lifting device 20. The opposing recess 50 may extend into the side wall or edge 24 (e.g. for a depth) and extend through the top surface 22 and bottom surface 23. The one or more opposing recesses 50 may include at least one concave recess 51. The concave recess 51 may face or open towards the loop forming member 40. In some embodiments, the opposing recess 50 may include one or more tapering recesses 52. The tapering recess 52 may connect with the concave recess 51. The tapering recess 52 increases the width W of the T-shaped member 30a, 30b or handle member 30 from the concave recess 51 towards the loop forming member 40. Alternatively stated, the depth of the tapering recess within the edge 24 decreases towards the loop forming member 40 or end 41, 42. The opposing recesses 50 may define at least a portion of the base member 30a2, 30b2 and/or top member 30a1, 30b1.

In some implementations, the width W of the lifting device 20 between opposing side walls 24 may varying in the transverse direction along the longitudinal direction/axis A. Along the longitudinal direction/axis A, the width W may decrease (e.g. adjacent the recesses 50) from a larger width (e.g. adjacent the top member 30a1, end 20a), then increase to a larger width (e.g. adjacent the loop forming member), then decrease (e.g. adjacent the recesses 50), and subsequently increase to a larger width (e.g. adjacent top member 30b1, end 20b). For example, the loop forming member 40 may have a first width W1 larger than the second width W2 of the base member 30a2, 30b2. Further for example, the top member 30a1, 30b1 may include a third width W3 substantially the same as the first width W1 of the loop forming member 40.

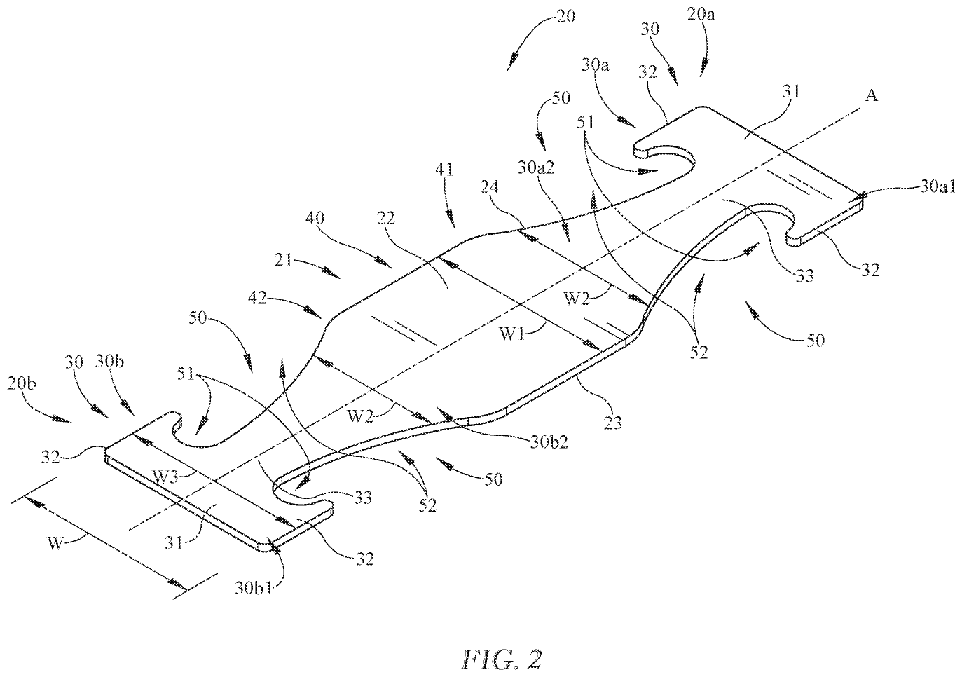

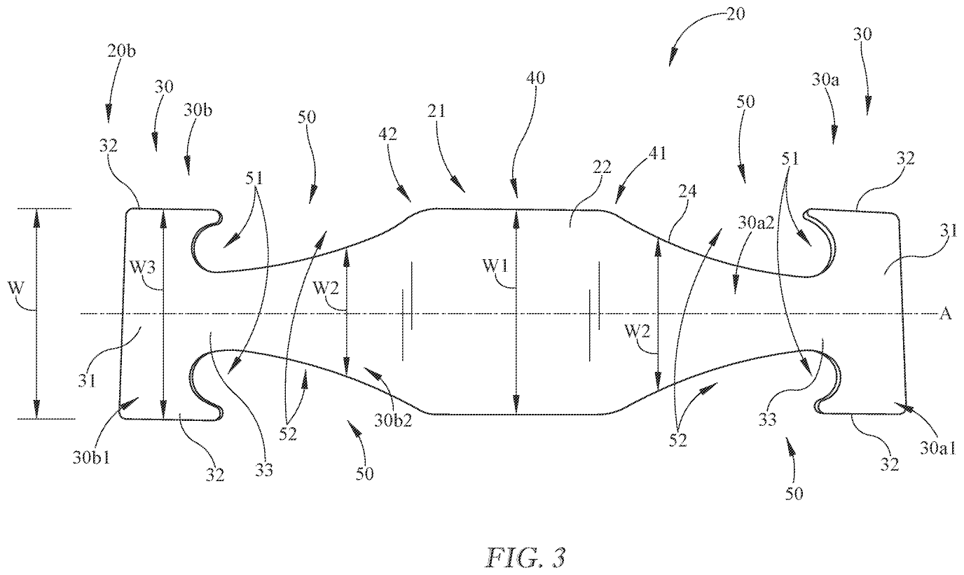

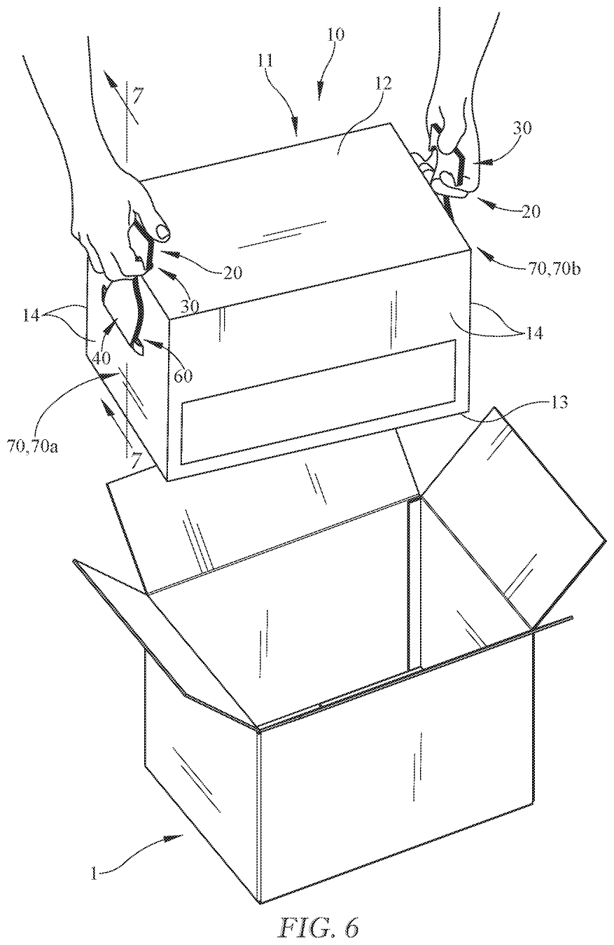

In some implementations, the lifting device 20 may be positionable between two or more positions/configurations to form a cradle or basket 60 to engage the one or more portions of the appliance 10 (e.g. lifting point/member 70). The lifting device 20 may be positioned between a planar/unfolded configuration (see FIGS. 2 and 3) and a looped/folded configuration (see FIGS. 1 and 5-7). In the planar configuration, the lifting device 20 may be substantially planar/flat and/or provide unfolded portions thereof. Alternatively stated, the cradle or loop 60 may not be defined in the planar configuration. In the folded configuration, the handle members 30 (e.g. T-shaped) at opposing ends 20a, 20b are brought together or overlapped to close/define the loop or cradle 60 thereby overlapping a portion of the loop forming member 40 and/or the opposing handle members 30. The loop or cradle 60 defined/formed engages or receives one or more portions of the appliance 10. In the folded configuration, the length of the lifting device is reduced. In the planar configuration, the lifting devices 20 may be stacked and/or stored (e.g. within box, etc.) before assembly or engagement with the appliance 10. In the planar configuration and/or a configuration different from the planar configuration (e.g. the folded configuration), the lifting device 20 may be engaged to or assembled with the appliance (e.g. side wall, lifting point, one or more appliance members/apertures, etc.). When in the folded configuration as shown in FIG. 6, the user may grab or use their hands/fingers to engage at least the two handle members 30 (e.g. opposing recesses, T-shaped members) folded upon each other. In the folded configuration as shown in the one embodiment in FIGS. 1, 5, and 6, the opposing recesses 50 of each handle member 30 align with each other when the handle members 30 or lifting device 20 are overlapped. The opposing/aligned and overlapped recesses 50 (e.g. aligned, folded together) may receive at least a portion of the user's finger or may be gripped by the user.

In some implementations, the lifting device 20, or portions thereof, may be of variety of materials. In the one embodiment shown, the lifting device 20 is of a cardboard or paper material. However, a variety of materials are contemplated. For example, the lifting device may be made of a plastic, fabric, rubber, rope, metal, and/or wood. Although the cross section is substantially rectangular in cross section, other shapes are contemplated. The lifting device 20 may be of a unitary material (e.g. cardboard, paper) as shown, however a plurality of materials may be used. As shown in the one embodiment, the lifting device is a single member. However, multiple members may be used in various embodiments.

In some implementations, the one or more lifting devices 20 may be used or combined with a variety of appliances 10. Although the appliance is a window air conditioner unit as shown in the one embodiment, a variety of other appliances may be manipulated by the one or more lifting devices 20. For example, the appliance may be a microwave, blender, toaster, dehumidifier, dishwasher, air fryer, range, oven, fan, refrigerator, freezer, etc.

In some implementations, the lifting device 20, or portions thereof, (e.g. loop/cradle, loop forming member) may engage one or more lifting points or mechanisms 70 (e.g. members, apertures) of the appliance 10. The one or more lifting points 70 engage or releasably secure with the lifting device 20 to manipulate the appliance 10. The lifting device 20 cradles the lifting points 70 when in the folded configuration. The one or more lifting points 70 may be in a variety of positions on the appliance 10. It should be understood that the lifting points of the appliance may be a variety of shapes, sizes, quantities, positions, and construction and still be within the scope of the invention. The lifting point may include or be defined by one or more through apertures 71/members 72. In some embodiments, the aperture(s) may have a dual function as a louver or vent opening of the appliance.

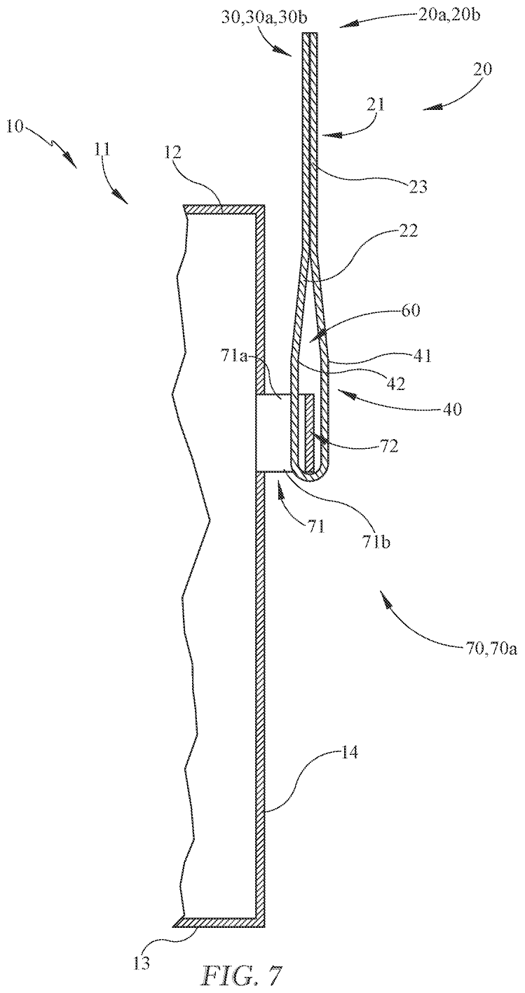

In some implementations, the appliance 10 and/or lifting device 20 may include one or more lifting points 70 (e.g. top wall, side wall, and/or bottom wall). The appliance or window air conditioner unit 10 may include a housing 11. The housing 11 may include a top wall 12, a bottom wall 13, and a plurality of side walls 14 connecting the top wall 12 with the bottom wall 13. The lifting point 70 may be included on one or more walls of the appliance 10. One or more side walls 14 of the plurality of side walls 14 may include or define the lifting point 70 (e.g. aperture, members), or portions thereof. The lifting point 70 may be adjacent the top wall 12. As shown in the one embodiment, the lifting point 70 may include a top through aperture/opening 71a connected to a bottom through aperture/opening 71b spaced from each other or defined by one or more members 72 of the side wall 14. Although the lifting point 70 or member 72 may project from the remaining portion of the side wall as shown in the one embodiment, the member 72 may be flush or recessed within the side wall 14. The opposing side walls 14 (e.g. between the front and back surfaces of the unit or appliance) may each include at least one lifting point 70. A first lifting device 20 may engage a first lifting point 70a on one first wall (e.g. side) and a second lifting device 20 may engage a second lifting point 70b on another or opposing second wall (e.g. side). The lifting device 20 or loop forming member 40 (e.g. folded configuration, cradle, portion) may pass through one or more through apertures 71 and cradle a portion (e.g. member) of wall (e.g. side, top, bottom) defining at least a portion of the through aperture 71. The lifting device may be inserted through the passageway or through opening between the top aperture 71a and the bottom aperture 71b. The cradle 60 of the lifting device 20 (e.g. handle members, loop forming member) formed in the folded configuration may receive the portion or member 72 of the lifting point 70 (e.g. aperture, member, portion). The lifting point or portion of the side wall/appliance may be horizontal member. In the folded configuration as shown in FIGS. 1 and 7, the pair of handle members 30 (e.g. T-shaped member) and the loop forming member 40 overlap and cradle/engage (e.g. cradle 60) the lifting point 70, or portions thereof. Being overlapped, the top or bottom surface 22/23 (e.g. in the direction of the fold) fold and face towards each other. Further when overlapped/folded, the top or bottom surface 22, 23, or portions thereof may touch or be in direct contact and the remaining portion may be or define the cradle or loop 60. The member 72 or portion of the appliance 10 or lifting point 70 may extend through the cradle 60 formed.

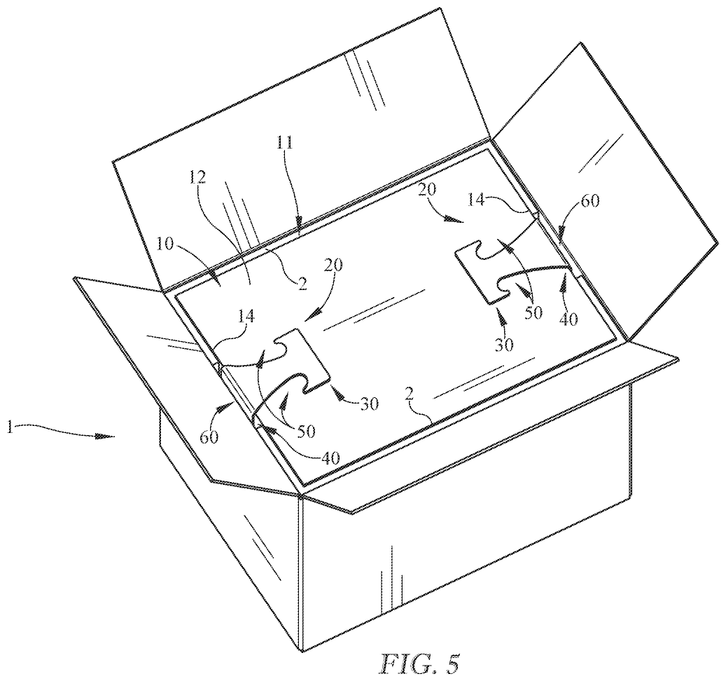

In some implementations, the lifting device 20, or portions thereof, may be visible and/or accessible to the user when stowed in the box or packaging 1. The box or packaging 1 may include packing material 2. Further, the lifting device 20, or portions thereof, may be visible to the user when stowed in the box 1 with (see FIG. 5) or without packing materials 2 surrounding/spacing the appliance 10 relative to the box 1. Although the lifting device 20 may be disconnected or separate from the packing material 2, if used, in some embodiments the lifting device, or portions thereof, may be combined or connected with packing material 2. As shown in FIGS. 5-7, the lifting device 20, or portions thereof, (e.g. one or more handle members, loop forming member) may extend above the wall or visible surface(s) of the appliance (e.g. top, side, bottom, etc.) within an open box when stowing and/or deploying. The lifting device 20, handle member 30, and/or loop forming member 40, or portion thereof, may extend above or be at an elevation above an uppermost extent of the wall/surface (e.g. top wall) of the appliance 10 when engaged to the lifting point. Further, the handle member 30 and/or loop forming member 40, or portions thereof, may be folded over the surface/wall (e.g. top wall) as shown in the one embodiment in FIG. 5. The user may be able to see and/or grip the lifting device 20, or portion thereof, to intuitively manipulate the appliance (e.g. when stowing, deploying, installing, before installment, during manufacture, and/or after manufacture). Although the lifting device may be preattached to the appliance upon opening the box as shown in FIG. 5, the user may attach or engage the lifting device upon opening the box.

In use, when the appliance 10 is in the box 1 and opened the lifting device 20, or portions thereof, may be visible and/or accessible to the user. The lifting device 20, or portion thereof, may be or extend above the top surface or wall 22 adjacent the box opening. Alternatively, the lifting device 20, or portions thereof, may not be visible and/or accessible when the box is open. Further, the box 1 may be opened by the user. With the lifting device(s) 20 cradling the lifting point(s) 70, the user may manipulate (e.g. lift/carry/deploy/stow) the appliance from/to or relative to the box/packaging 1 (e.g. packing material, if used). In some implementations, the lifting device(s) 20 may be used to stow and/or deploy the appliance(s) relative to the opened box/packaging 1 (e.g. packing material, if used). The lifting device(s) 20 may be engaged to the lifting point(s) 70 of the appliance. For example, the lifting device 20 may be inserted through one or more through openings 71 or engage one or more members 72 of the appliance (e.g. top wall, side wall, bottom wall, etc.). The lifting device(s) 20 may be disengaged from the lifting point(s) 70 of the appliance once manipulated by the user. Alternatively, the lifting devices, or portions thereof, may remain with the appliance if desired. The lifting device may be preattached to the appliance or subsequently attached. The one or more lifting devices 20 may be engaged/disengaged from the appliance 10 or lifting points 70 when in the planar configuration and/or folded configuration different from the planar configuration. The user may create the cradle 60 of the lifting device 20 by overlapping the lifting device, or portions thereof. The overlapping or creating of the cradle 60 may be positioned about or surround at least a portion of the lifting point 70 (e.g. member, side wall, appliance, portion). In some implementations as shown, the appliance 10 may be a window air conditioner unit provided with the lifting device(s) 20. It should be understood that a variety of appliances may be used with the lifting device(s). The appliances may be of a variety of shapes, sizes, quantities, and constructions and still be within the scope of the invention.

It will be appreciated that various additional modifications may be made to the embodiments discussed herein, and that a number of the concepts disclosed herein may be used in combination with one another or may be used separately. Therefore, the invention lies in the claims hereinafter appended.

1. A lifting device for use with an appliance, comprising:
an appliance having a housing, wherein the housing includes a top wall, a bottom wall, and a plurality of side walls connecting the top wall with the bottom wall, and wherein at least one first side wall of the plurality of side walls includes at least one through aperture;
a pair of handle members and a loop forming member interconnecting the pair of handle members; and
wherein the loop forming member passes through the at least one through aperture and cradles a portion of the at least one side wall defining the through aperture whereby the pair of handle members and the loop forming member overlap.

2. The lifting device of claim 1 wherein the appliance is a window air conditioner unit.

3. The lifting device of claim 1 further comprising a second lifting device, wherein the second lifting device engages at least one second side wall opposing the at least one first side wall.

4. The lifting device of claim 1 wherein the pair of handle members is in a position at an elevation above an uppermost extent of the top wall of the appliance.

5. The lifting device of claim 1 wherein each handle member includes opposing recesses, the opposing recesses of each handle member align with each other when the pair of handle members are overlapped, the opposing recesses are configured to receive the user's finger.

6. The lifting device of claim 1 in combination with a box and a packing material between the box and the appliance, wherein the pair of handle members are disconnected from the packing material.

7. The lifting device of claim 1 wherein the portion of the at least one first side wall is a horizontal member.

8. A lifting device for use with an appliance, comprising:
a pair of handle members and a loop forming member interconnecting the pair of handle members, wherein each handle member is a T-shaped member; and
the lifting device being configurable between a planar configuration and a folded configuration, when in the planar configuration the lifting device is substantially flat and when in the folded configuration the pair of T-shaped members and the loop forming member overlap to form a cradle.

9. The lifting device of claim 8 wherein the T-shaped member includes a top member intersecting a base member, wherein each base member of the pair of T-shaped members engages the loop forming member.

10. The lifting device of claim 9 wherein the loop forming member has a first width and the base member has a second width, and wherein the first width is larger than the second width.

11. The lifting device of claim 10 wherein the top member includes a third width, wherein the third width is substantially the same as the first width.

12. The lifting device of claim 8 wherein each T-shaped member includes opposing recesses on opposing edges, each opposing recess includes a concave recess opening towards the loop forming member.

13. The lifting device of claim 12 wherein each opposing recess includes a tapering recess thereby increasing a width of the T-shaped member from the concave recess towards the loop forming member.

14. The lifting device of claim 8 in combination with a box and an appliance.

15. The lifting device of claim 8 wherein the pair of T-shaped members are similar to each other.

16. The lifting device of claim 8 is made of a cardboard material.

17. A method of manipulating an appliance from packaging, the method comprising:
providing a box;
providing an appliance in the box, wherein the appliance includes opposing side walls, each of the opposing side walls includes a lifting point;
providing a lifting device engaging the lifting point, wherein the lifting device includes a pair of handle members and a loop forming member interconnecting the pair of handle members;
overlapping at least a portion of the pair of handle members and the loop forming member to create a cradle receiving the lifting point of the appliance; and
manipulating the appliance via the lifting devices to stow and/or deploy the appliance relative to the box.

18. The method of claim 17 including manipulating the appliance via the lifting devices to stow the appliance relative to the box.

19. The method of claim 17 including manipulating the appliance via the lifting devices to deploy the appliance relative to the box.

20. The method of claim 17 wherein the lifting point includes a least one aperture, and further comprising inserting the lifting device through the at least one aperture.

21. The method of claim 20 further comprising creating the cradle by overlapping the lifting device about the lifting point.

22. The method of claim 17 further comprising opening the box and visually seeing the lifting devices above a top wall of the appliance.

23. The method of claim 17 wherein the appliance is a window air conditioner unit.

24. The method of claim 17 wherein each handle member is a T-shaped member.
